(19) United States
(12) Patent Application Publication
(10) Pub. No.: US 2012/0146943 A1
(43) Pub. Date: Jun. 14, 2012

(54) TOUCH SENSING OUTPUT DEVICE

(75) Inventors: Peter Douglas Fairley, Plymouth (GB); Paul Richard Simons, Cambridge (GB); Stephen Michael Pitchers, Cambridge (GB); Alwin Rogier Martijn Verschueren, Eindhoven (NL); Martinus Hermanus Wilhelmus Maria Van Delden, Eindhoven (NL); Kars-Michiel Lenssen, Eindhoven (NL); Manfred Muller, Eindhoven (NL); Leon Wilhelmus Godefridus Stofmeel, Eindhoven (NL)

(73) Assignee: KONINKLIJKE PHILIPS ELECTRONICS N.V., EINDHOVEN (NL)

(21) Appl. No.: 13/390,441

(22) PCT Filed: Aug. 26, 2010
(86) PCT No.: PCT/IB10/53832

§ 371 Date: Feb. 14, 2012

(30) Foreign Application Priority Data
Sep. 3, 2009 (EP) 09169392.9
Apr. 9, 2010 (EP) 10159519.7

(51) Int. Cl. G06F 3/044

(52) U.S. Cl. 345/174

(57) ABSTRACT

A device having touch sensor input functionality, comprises first and second control electrodes (40,42) lying in a common plane. The device is operable in at least two modes, comprising: a first mode in which the light transmission characteristics are altered by controlling the movement of the charged particles under the influence of control signals applied to the first and second control electrodes; and a second mode in which the first and second control electrodes are coupled to a capacitance sensing means, for detecting a change in capacitance caused by the proximity of an object to be detected.

### FIELD OF THE INVENTION

This invention relates to touch sensing output devices, for example touch sensing displays.

### BACKGROUND OF THE INVENTION

The use of capacitance sensing as a means for detecting touch input is well known and the subject of much current development.

Applications at the more advanced functionality end of the spectrum are typified by the high resolution capability offered by the Apple iPhone, and at the reduced functionality end lie simpler on-off touch sensors for operating electrical appliances such as lighting.

At the heart of all these capacitance sensing systems is a detection system that measures a sense capacitor that is designed as the input ‘switch’. Each switch is designed as a flat conductive pad whose surface area corresponds to the sensed area for that particular switch. The value of this sense capacitor is designed so as to be dependent upon the proximity of a user's finger or an input stylus. As soon as the user's finger is sufficiently close to the switch a threshold change in capacitance is reached which triggers a change in the system being operated.

Perhaps slightly less well-known is the in-plane electrophoretic (IPEP) display effect. In this, colored dye-tagged or solid pigment particles that are suspended in oil cells are moved between two regions of a pixel. In the open-pixel state the particles are all moved to a small pad within the pixel and appear to the distant user as a small dark speck. The clear oil then renders the pixel largely transparent, save for this small dark speck and the pixel walls. In the closed-pixel state the colored particles are spread-out across the pixel's area and the pixel reflects a color determined by the dye in the particles. Greyscale transmission values and mixed colors are also possible, offering numerous potential display and ‘hiding panel’ applications. With this display effect, the charged colored particles are moved using an electric field, the process being termed “electrophoresis”.

Various methods of adding a touch-based sensor input to a display are known. The predominant approach for capacitance-based touch sensing involves measuring the capacitance of an input switch which is constructed using transparent electrodes that are located a small distance in front of the display effect. This requires the use of an overlay screen. With this technique, an array of capacitance-measuring electrodes are distributed across the surface of this overlay screen for the purpose of measuring touch-input. The electrodes are made from a thin layer of indium-tin-oxide (ITO) in order to make them transparent, and thereby permit the user to view the display that is located behind the capacitance-measuring electrodes. The problem with the use of ITO electrodes is that even with their 95% transparency they reduce the display brightness, wasting power.

Other techniques are known for integrating a touch-input sensor with a display backpane. In some cases a touch-input event is inferred by measuring changes in the reflectance of a small amount of the backlight power back into a photodiode that is located within the pixel. The photodiode continually monitors the reflected signal, and as soon as a finger touches the surface the change in reflectance triggers a threshold and identifies a ‘touch’ event at this location. The problem with this technique is that it sacrifices pixel aperture in favor of the area demanded by the photodiode and its readout electrodes, reducing display brightness.

Yet another integrated touch-measurement technique monitors the capacitance between two in-pixel electrodes that are located on the display backpane. The capacitance between these electrodes is affected by their separation from a corresponding bump that is physically attached to the coverglass and extends down into the display cell (typically liquid crystal). Touching the display results in its local deformation, and the consequent change in gap between bump and electrode leads to a change in capacitance and hence triggers a ‘touch’ event. Pixel-scale resolution can be achieved by arranging one bump in each pixel. However, pixel aperture must be sacrificed for these ‘bumps’ and their capacitance-monitoring electrodes, leading once again to a reduction in display brightness and wasted power.

The invention seeks to incorporate touch-input sensing into a display cell without reducing the display brightness.

### SUMMARY OF THE INVENTION

According to the invention, there is provided an output device having touch sensor input functionality, comprising:

at least first and second control electrodes lying in a common plane over a common substrate for controlling a light transmission characteristic of the device; and

a suspension of charged particles in a layer overlying the common substrate, wherein the device is operable in at least two modes, comprising:

a first mode in which the light transmission characteristics are altered by controlling the movement of the charged particles under the influence of control signals applied to the first and second control electrodes; and

a second mode in which the first and second control electrodes are coupled to a capacitance sensing means, for detecting a change in capacitance caused by the proximity of an object to be detected.

The invention is based on the recognition that in the particular case of IPEP effects, the particles that change the display effect in IPEP are moved by electric fields that are parallel to the plane of the device.

The invention is based on the recognition that suitably-designed electrodes can both drive the light transmission (i.e. display) effect as well as can be used for touch-input capacitance-sensing. Significant advantages are obtained in addition to the lack of additional layers being required, including reduced complexity in driving the system, and reduced manufacturing complexity.

Some in plane switching designs enable the absence of a ground plane, and this means the sensitivity of the touch sensing arrangement is not hampered by the presence of the ground plane. However, in designs having a ground plane, it can be used as part of the touch sensor circuitry, with a differential capacitance sensing being implemented.

The operation occurs in two phases. During a drive phase, the electric fields generated by the electrodes move the particles in the same way as before. By switching to a capacitive sensing phase, during which the capacitance between the electrodes is measured or the differential capacitance to a ground plane, touch-input is sensed. These two phases can be sequential, but they can also be combined so that they take place at the same time.

The device can comprise an electrophoretic passive or active matrix display device having an array of rows and columns of display pixels disposed over the common substrate, wherein each pixel comprises respective first and second control electrodes and a respective suspension of charged particles.

The system of the invention gives an increase in display brightness compared to systems that require additional touch-sensor hardware overlying the display, and therefore a reduction in wasted power. Subsequent manufacturing advantages are permitted by the integration of the driving and sensing electrodes.

An insulating cover layer is preferably provided over the charged particle layer. In particular, no electrode structures are present between the charged particle layer and the surface of the device as presented to the user. This means the electric field lines generated by the control electrode can extend into the free space over the device. Thus, in the second mode, electric field lines between the first and second control electrodes extend beyond the cover layer.

A control circuit can be provided for controlling the switching between the first and second modes in a time division multiplex manner. This provides separate distinct modes of operation. The control circuit can apply DC control voltages to the control electrodes in the first mode, and apply a pulsed, or AC sense voltage between the control electrodes in the second mode.

In an alternative arrangement, a control circuit is provided for applying control voltages to the control electrodes comprising a pulsed or ac sense voltage for the second mode with a superposed DC offset for the first mode, wherein the first and second modes are implemented at the same time.

In the second mode, the detected change in capacitance can relate to:

the capacitance between the first and second electrodes; or

the capacitance between each electrode and a ground.

The latter option can be implemented in a matrix array. By measuring the load capacitance on each row and column in order to determine the proximity and x,y coordinates of a finger.

The invention also provides a method of controlling the light transmission characteristics of an output device and implementing a touch sensor function, using an output device comprising at least first and second control electrodes lying in a common plane over a common substrate for controlling a light transmission characteristic of the device and a suspension of charged particles in a layer overlying the common substrate, comprising:

in a first mode, altering the light transmission characteristics by controlling the movement of the charged particles under the influence of control signals applied to the first and second control electrodes; and

in a second mode, coupling the first and second control electrodes to a capacitance sensing means, for detecting a change in capacitance caused by the proximity of an object to be detected.

### BRIEF DESCRIPTION OF THE DRAWINGS

Examples of the invention will now be described in detail with reference to the accompanying drawings, in which:

FIG. 1(a) is a cross section of a typical display;

FIG. 1(b) shows the electric field lines generated by the touch sensor electrodes in the design of FIG. 1(a);

FIG. 2 shows a known display design, which can be modified by a suitable control system in order to function in accordance with the invention;

FIG. 3 shows the operation of an IPEP display with hexagonal cells in plan view (top image) and in cross section (bottom view);

FIG. 4A shows the electric field lines from the display-driving electrodes during the sense mode, with no finger present;

FIG. 4B shows the electric field lines from the display-driving electrodes during the sense mode when a finger is present;

FIG. 5 shows an example of suitable circuit diagram for operating both phases;

FIG. 6 shows a more advanced approach for generating a pulsed capacitive sense signal which has a DC offset;

FIG. 7 shows a more complete driving circuit implementing the approach explained with reference to FIG. 6;

FIG. 8 shows schematically how the invention can be applied to a matrix of rows and columns of pixels;

FIG. 9 shows a second known display design which can be modified by a suitable control system to function in accordance with the invention;

FIG. 10 shows the operation of the device of FIG. 9 in accordance with the invention;

FIG. 11 is used to explain an alternative capacitor sensing approach which can be employed; and

FIG. 12 is used to show that a hiding panel function can be implemented.

### DETAILED DESCRIPTION OF THE EMBODIMENTS

The invention will first be described in relation to a display device, although it will be apparent that the invention can be applied more generally to other devices which have variable light transmission characteristics.

In all common existing displays, particularly in liquid crystal (LC), organic light-emitting diode (OLED), and most existing electrophoretic display technologies, the requirement for separating the array of capacitance touch-measurement electrodes from the display front surface is a consequence of the continuous ground plane on their front surface.

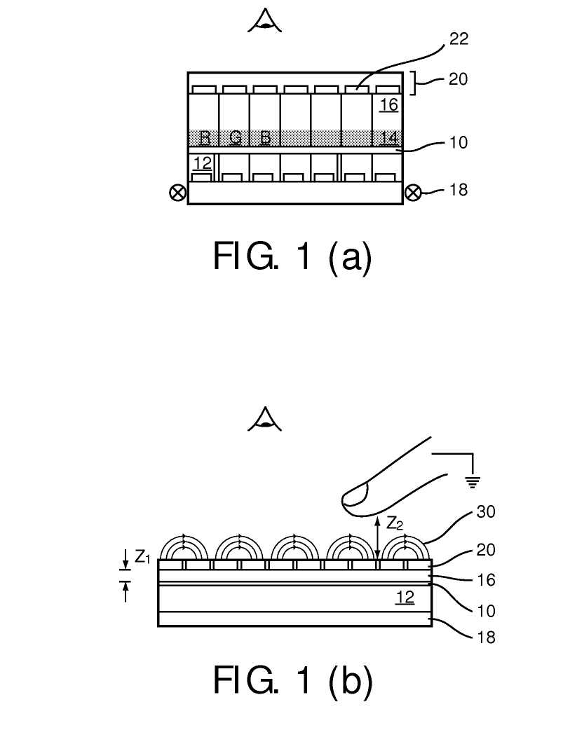

This is shown in FIG. 1. FIG. 1(a) is a cross section of a typical display that has a ground plane 10 overlying the LC cells 12. A color filter layer is shown as 14 and the coverglass is shown as 16. The light from a backlight 18 is modulated by the display pixels.

An attached capacitive-based touch-sensitive layer 20 is provided over the coverglass, and this uses additional transparent (ITO) electrodes 22.

FIG. 1(b) shows the electric field lines 30 generated by the touch sensor electrodes in the design of FIG. 1(a). Owing to the necessarily large separation between the electrodes and the ground plane, these field lines can be intercepted by a nearby finger. By contrast the electric field lines generated by the display electrodes (which are not shown) terminate at the ground plane and do not reach the finger.

The ground plane is inherent in all common display effects. In some examples, the electric fields that are needed to modulate their intensity are applied in a direction that is normal (perpendicular) to the plane of the display. Some known electrophoretic displays also use a ground plane since the electrophoretically-driven particles are moved in a direction perpendicular to the plane of the display, again requiring the driving electric fields to be in a direction normal to the plane of the display.

If the capacitance-monitoring electrodes are located too close to the display ground plane, the latter would act as a shield, shunting the capacitance-sensing signal that emanates from the capacitance-monitoring electrodes to this ground plane and thereby preventing the effective operation of the capacitance-monitoring touch screen. Consequently, the presence of the ground plane in all common display effects places a limit on the minimum proximity between itself and the capacitance-measuring electrode array. In practice, for sensitive operation, typical field-fringing geometries require that the ground plane-to-sense electrode separation (z1) exceeds the minimum ground plane-to-finger separation at the point of triggering a ‘touch’ event (z2). So for example in order to detect a finger touching the front surface of a 700 μm coverglass layer using electrodes on its reverse side, then this reverse side must be located at least 700 μm in front of the display's ground plane.

A further consequence of the display ground plane is that it can be thought to prevent the use of the same electrodes that drive the optical effect as touch-input capacitive sensing electrodes. This follows from the previous argument—the ground plane acts as a screen. Unfortunately the ground plane of the display must be on its front surface due to numerous display assembly arguments. So, in all common display effects the touch-input capacitive-sensing electrodes must be both separate-from and in front of the ground plane. If the touch-sensitive electrodes were located behind the ground plane then their sensing electric field lines would simply be terminated at this ground.

In conclusion, display effects which have a continuous ground plane, and this includes all common effects such as LC, OLED, and existing electrophoretic displays (such as SiPix and E Ink), cannot simply re-use their drive electrodes as capacitive touch-sensing electrodes. Consequently the touch sensor is applied as a separate layer, often located on the front surface of the display's color filter plate as shown in FIG. 1(a).

This invention provides display designs which enables the same electrodes to be used for generating the display effect as for providing touch sensing. In some aspects, the invention relates to display devices that do not use a ground plane. In other aspects, the invention makes positive use of a ground plane of the display within the touch sensing circuit.

In particular, this invention provides the integration of a capacitance-based touch sensor with the in-plane electrophoretic (IPEP) display effect. Each pixel of the display comprises at least first and second pixel control electrodes lying in a common plane, and a suspension of charged particles in a layer overlying to the common substrate. In accordance with the invention, the device is operable in at least two modes, comprising a normal display mode and a sensing mode in which the first and second pixel control electrodes are coupled to a capacitance sensing means, for detecting a change in capacitance caused by the proximity of an object to be detected.

The invention thus provides the integration of capacitive touch sensing with the IPEP display effect and the use of the same display-driving electrodes as the touch-sensing electrodes. In one aspect, the invention is based on the realization that since there is no ground plane in some implementations of the IPEP display effect (which will be termed “lateral movement only IPEP display”), the integration of this type of sensing becomes possible. In effect, they are complementary technologies. The primary advantage of the invention is an increase in display brightness and hence a reduction in wasted power. An additional advantage is that by eliminating the brittle ITO electrodes that are currently used to make capacitive touch-sensors, the interactive display can be used in applications that require flexibility or increased robustness. This problem is particularly acute in flexible displays because, as described above, the capacitive electrodes are necessarily on the display's surface where they have the largest bending radius and therefore undergo the largest strain. Subsequent manufacturing advantages are permitted by the integration of the driving and sensing electrodes. In other aspect, the invention provides the integration of the touch sensing with a display which combines in plane switching as well as transverse control of the particle positions.

In the lateral movement only IPEP display, the particles are moved by electric fields in directions that are parallel to the plane of the display. Thus, electrodes are only required to be placed such that they generate electric fields that are parallel to the plane of the display. Consequently there is no need for a continuous ‘ground plane’.

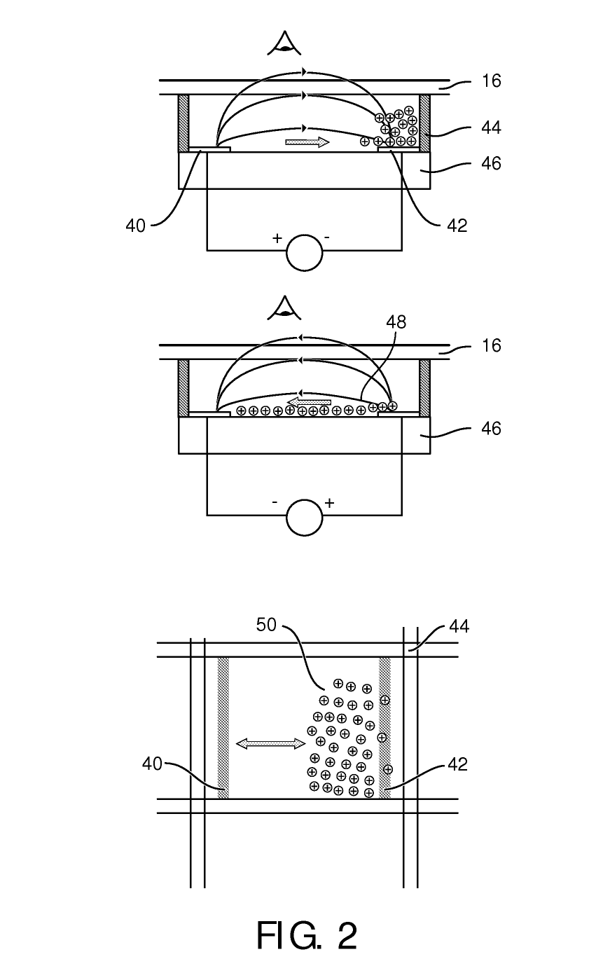

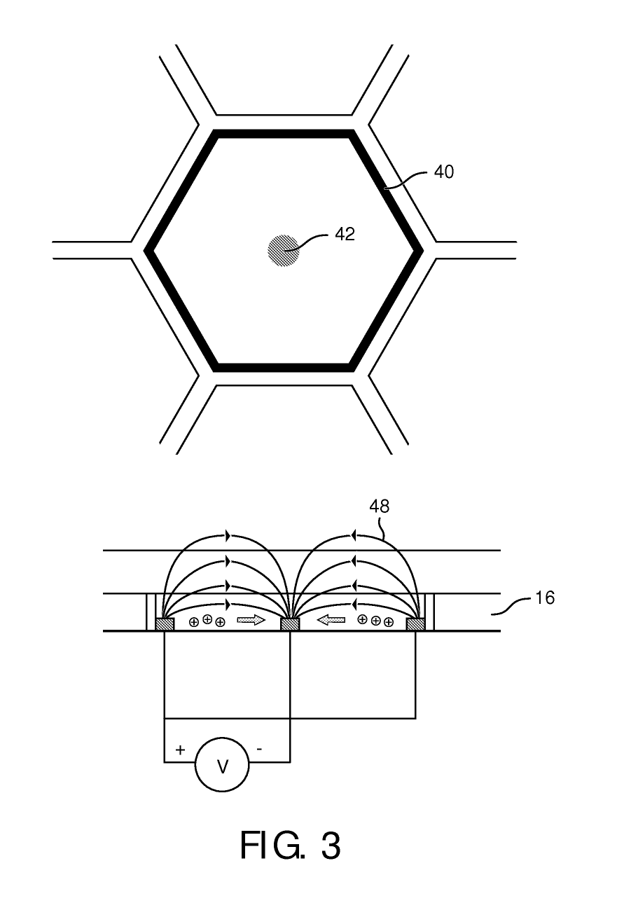

The operation of the lateral movement only IPEP display effect is now described in more detail with the aid of FIG. 2, which shows a known display design, which can be modified by a suitable control system in order to function in accordance with the invention.

In a typical IPEP display pixel cell of this type, there are nominally two electrodes 40,42 located at the base of each cell. Each cell is defined by cell walls 44 which prevent the lateral spreading of the colored particles toward other electrodes.

FIG. 2 shows operation of the IPEP display effect with rectangular cells, and is a cross section of the display with the pixel ‘opening’ (top image), a cross section of the display with the pixel ‘closing’ (middle image) and plan view of the cell (bottom image).

In the cell design of FIG. 2, there is one electrode 40 running along one edge of the cell and another electrode 42 running along the parallel edge of the cell. Depending on the use of the display (reflective, transmissive or purely light modulating), behind the cells is a layer 46 which can be a backlight or a reflection pattern, or a transparent layer. The cover layer 16 is an insulator e.g. glass, and no ground plane electrode is needed.

The middle image shows the electric field lines 48 and shows that these penetrate through the cover layer 16.

The bottom image shows how the charged particles 50 move between different positions depending on the voltages applied.

FIG. 3 shows the operation of the lateral movement only IPEP display effect with hexagonal cells in plan view (top image) and a cross section of the display with pixel ‘closing’ (bottom view).

In the cell design of FIG. 3 there is one electrode 42 in the centre of each cell, and the other electrode 40 surrounds the perimeter of the cell.

This invention can be applied to both designs, and to many other designs. Indeed, the use of only two electrodes per pixel is only one example. More complicated drive schemes use more electrodes to enable an increase in the response speed. Whilst drawn for only one pixel, the invention is of course also applicable to pixel cell geometries in which the connections to the pixel electrodes are arranged in the standard format of rows and columns, as well as for irregular pixel cell geometries. These measures will be known to those skilled in the art. The invention is described for pixels forming the display which have at least two electrodes (which is the minimum) and these are then used for the capacitance sensing function. The invention is described specifically in a situation where the capacitance between these two electrodes is measured in order to determine the proximity of a finger, although the invention is also applicable to measurement techniques in which the capacitance between either pixel electrode and ground in the external world is measured. An example is given further below.

The particular arrangement of the electrodes and the required drive scheme for normal display driving does not alter the applicability of the invention, provided no significant electric field shielding takes place above the electrodes.

During the “drive” phase, a DC potential difference is applied between the two electrodes 40,42, and the resulting electric field component that is parallel to the plane of the display acts to drive the charged colored particles through electrophoresis. This is the usual operation of the display effect.

In accordance with the invention, there is an additional “sense” phase during which the capacitance between these electrodes is measured. The first and second pixel control electrodes are then coupled to a capacitance sensing means, for detecting a change in capacitance caused by the proximity of an object to be detected.

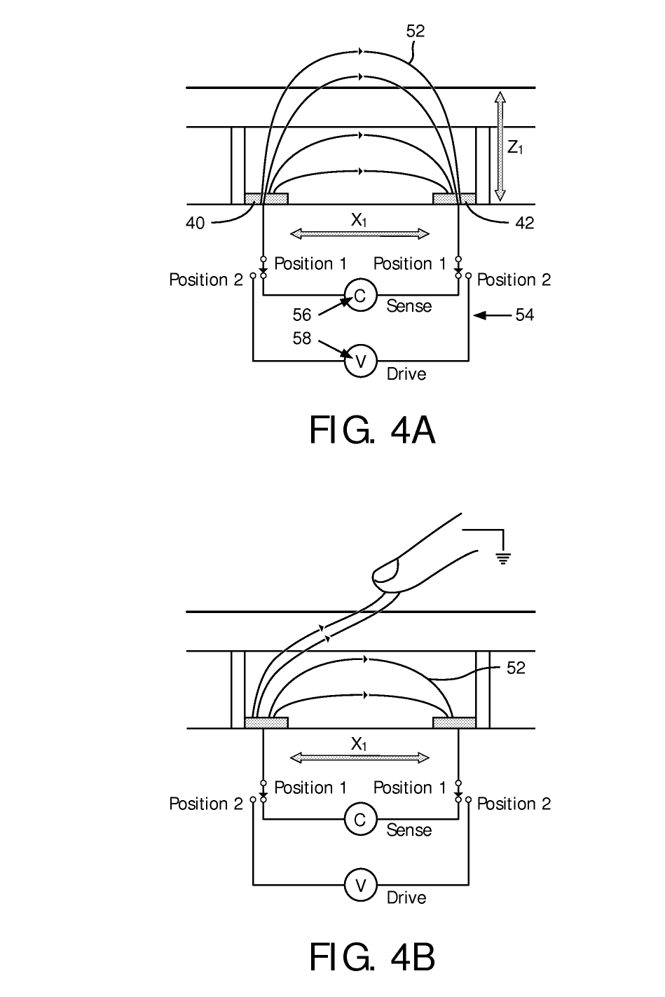

FIG. 4A shows the electric field lines 52 from the display-driving electrodes 40,42 during the sense mode, with no finger present, and FIG. 4B shows the electric field lines 52 from the display-driving electrodes during the sense mode when a finger is present.

The control circuit 54 is shown schematically as a capacitance sensing means 56 and a driving means 58 for applying the normal display driving voltages. The circuit 54 switches between modes by switching between these circuits.

The sense phase is affected by the proximity of nearby grounds, or more specifically a user's finger or input stylus that is close to the front of the display. The electric field pattern in the x-z plane is shown in the presence and absence of a finger touching the front of the display in FIGS. 4A and 4B. Since no ground plane is required for the IPEP display effect, when an electric field is applied between the electrodes in the cell, some of these electric field lines have a component in the vertical direction and these penetrate through the front of the display cover glass as shown.

Consequently, touching the front of the display with a finger changes the capacitance between the electrodes because any charge that is applied to one electrode plate is partly shunted to ground by the finger. This operation requires the field lines to penetrate through the display cell and through the cover glass. To a reasonable approximation, significant electric field lines will penetrate the cover glass when their lateral (x or y) separation is greater than the vertical (z) distance to the front of the coverglass. This requires x1>z1 in FIG. 4A.

Further optimization is of course possible by using specific electrode patterns and through judicious choice of the materials in the cell sandwich and their dielectric constants. Such optimization is well known to those practiced in the art. It is noted that in existing designs the pixel size is typically 700 μm by 700 μm, and since the coverglass thickness is also 700 μm, the above condition is satisfied, and sensitive touch-sensing is possible with no modification.

It is also possible detect touch-input cell designs that have a ratio of x1/z1 substantially less than unity, albeit with reduced touch sensitivity. In order to prove that this effect works a sample IPEP panel with a total display area of approximately 25 mm by 25 mm has been analyzed. A segment of the display with an area of approximately 4 mm by 25 mm arranged as a strip of parallel interdigitated electrodes running the entire width of the display has been driven.

The inter-electrode spacing (x1) was 100 μm, electrode width was 100 μm and the total distance from the electrodes to the front of the display (z1) was 160 μm. This gives a x1/z1 ratio of 100/160=0.625, and a touch event is easily detectible. Using this non-optimized test setup the capacitances using a standard laboratory capacitance meter were measured as shown in Table 1.

TABLE 1
Measured capacitances of a test IPEP display.

| | | Change in |
|---|---|---|
| Situation | Capacitance (pF) | capacitance (%) |
| Reference, no finger present | 39.00 | n/a |
| Finger touching front cover glass | 35.96 | −7.79 |

The ˜8% change in capacitance was measured in a cell design that was far from optimized for touch-input sensing, and consequently much greater changes are expected with improved cell designs. In spite of this, the ˜8% change is easily detected using a commercial capacitive touch-sensing IC directly electrically connected to the panel.

The text above describes the two (drive and sense) phases in which the system operates. The same electrodes that drive the display effect are also used as touch-sensitive electrodes.

An example of a possible driving scheme is now described in more detail. However, the invention is not dependent upon the use of a particular capacitance measurement technique in the sense phase. By way of example, capacitance measurement through the detection of charge using a pulsed waveform is assumed. In this approach, a pulsed voltage is applied to a transmitting electrode and the modulation of charge on an associated receiving electrode is detected. The amount of charge modulation at the receiving electrode is dependent upon the capacitance between the two electrodes, and this is dependent upon the proximity of the finger. In order to avoid a net displacement of the particles during the sense phase the driving signal must be ac coupled, although more complex drive schemes are possible as described below.

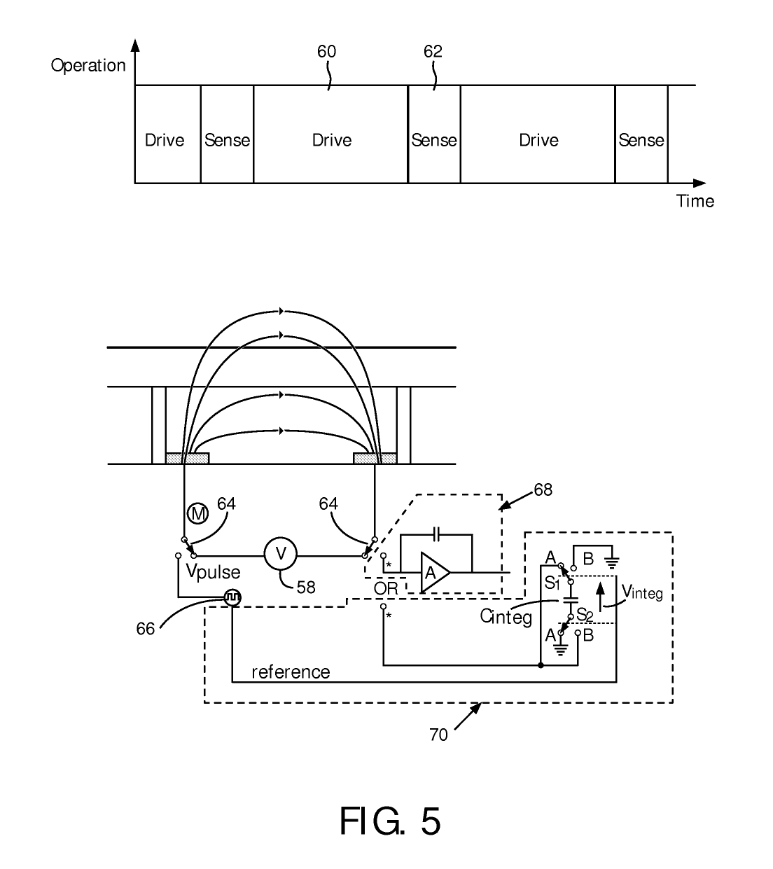

A suitable circuit diagram for operating both phases is shown in FIG. 5 which shows a timing diagram and circuit diagram for time-division multiplexed (TDM) driving of the IPEP display effect in the Drive and Sense phases.

The circuit operates in a TDM fashion, with one timeslot allocated 60 to driving the particles in the display and the subsequent timeslot 62 is allocated to sensing the inter-electrode capacitance.

The circuit comprises a switch arrangement 64 which selects between the conventional DC voltage source 58 and a pulsed voltage source 66. Two possible arrangements are shown in FIG. 5.

The operation of the switches 64 is such that during the drive phase, a DC voltage is applied to the cell. During the capacitive sense phase, this DC voltage is disconnected, and a separate pulsed sense voltage is applied to one electrode of the cell.

In one example, the other electrode of the cell is connected to a charge-sensitive (transimpedance) amplifier 68, which measures the current for sensing purposes. The voltage is then held constant at that electrode by the virtual earth of the amplifier.

In the other example 70, the other electrode is connected to a switched storage capacitor C_{integ} upon which the charge is integrated. In this example, the inter-electrode capacitance is measured by determining the amount of charge transferred between the two pixel electrodes when a pulsed square wave source is applied to one of these two electrodes. The storage capacitor C_{integ} integrates the transferred charge over a duration of one or more cycles of the square wave source 66. To improve signal integrity, integration may be required to take place over more than one cycle. In this case, switches S1 and S2 are necessary, and act to synchronise the connection to C_{integ} in order to ensure that charging acts to increase the voltage across C_{integ} (which is shown as V_{integ}) in only one (positive-going or negative-going) direction. During positive-going voltage transitions of the pulsed source 66 the switches are for example in position A, causing V_{integ} to increase in a positive direction. During negative-going transitions from 66 the switch is forced into position B by the reference signal from 66, causing V_{integ} to again continue to increase in a positive direction, thereby increasing the net voltage. Following the sampling of the predetermined number of cycles from 66 the voltage V_{integ} is measured and C_{integ} is discharged prior to the next inter-electrode capacitance sampling period 62 by a circuit (not shown).

The voltage integrated on C_{integ} is representative of the amount of charge transferred and hence represents the inter-electrode capacitance.

In simplified designs, the voltage V_{integ} is measured after only one cycle, although greater sensitivity is provided by sampling over many cycles of source 66 at the expense of a longer sampling interval 62. It will be apparent to those familiar with the art that many alternative techniques of measuring the inter-electrode capacitance exist, of which this is one example. It will also be apparent that an alternative to the described technique of measuring the inter-electrode capacitance is to measure the capacitance between either pixel electrode and ground in the external world using similar techniques.

In both approaches, some of the display driving time is sacrificed in favour of touch-sensing time.

The time overhead required for the sensing is dependent upon the frequency at which touch-input must be detected. For example, a driving time to sensing time ratio of 10:1 would barely affect the time required for the display to change its optical state.

However, a more advanced drive scheme shown in FIG. 6 uses a pulsed capacitive sense signal which has a DC offset.

FIG. 6 shows a circuit diagram and waveforms for summing the dc drive voltage V_{dc} and the pulsed capacitance-sensing voltage 72 using a summing amplifier 76. The output 74 is provided to one of the electrodes (in FIG. 5) and has a dc offset.

The net DC value of the drive signal is equal to the DC value required to drive the display so that the colored particles are also moved whilst the capacitance is being monitored. In so doing, no additional time overhead is required for the sensing phase.

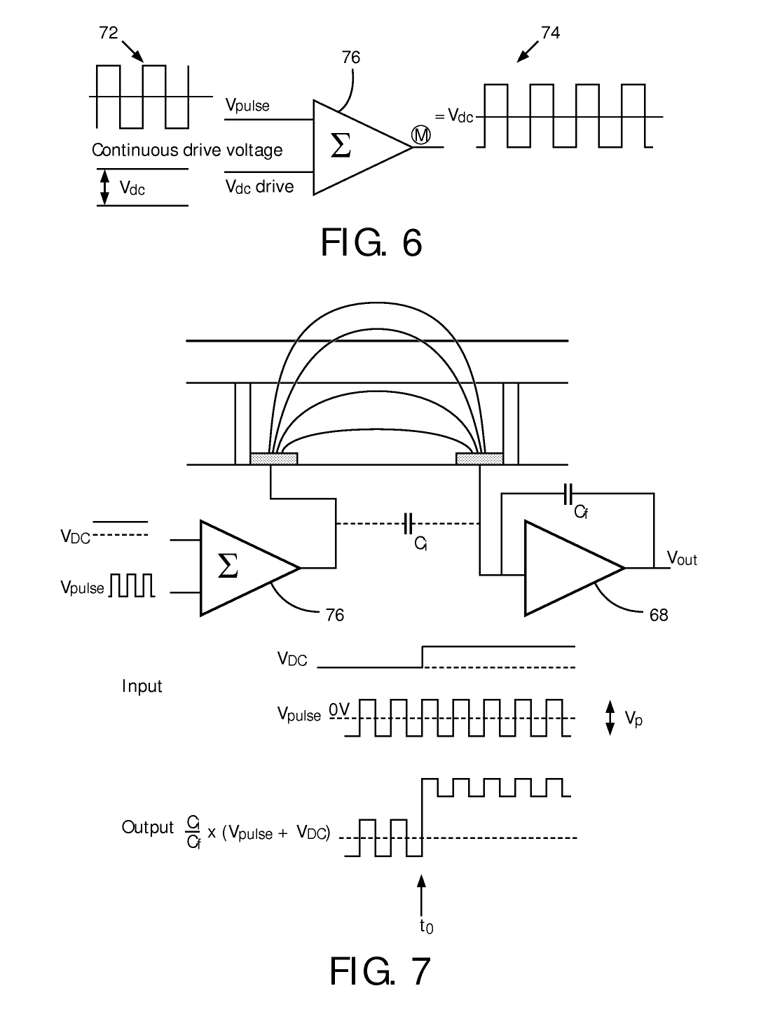

A more complete driving circuit that avoids the sensing time overhead shown in FIG. 7.

FIG. 7 shows a circuit diagram and waveforms showing operation of the IPEP display with combined drive and sense phases. The transient pulse shown in the “input” VDC voltage waveform at time t0 occurs during a change in display driving voltage. Lock-in techniques are used to permit continuous operation.

Thus, in this approach, the driving and sensing occurs simultaneously. As in FIG. 6, the DC drive signal is summed with the pulsed sensing signal using a summing amplifier 76 and this drives the transmitter electrode. The receiving electrode is connected to the virtual earth input of a transimpedance amplifier 68 in order to maintain the voltage of one electrode in the cell at a known reference voltage. The output of the transimpedance amplifier will be a pulsed signal whose amplitude is dependent upon the capacitance between the drive and sense electrodes. The amplitude of this signal which can be determined using, for example, lock-in techniques again indicates the proximity of a finger.

Other, more-optimized switched-capacitor charge-nulling techniques could be used to determine the signal amplitude and are well-known to those practiced in the art.

Again, in simplified designs only one pulse may be required for the capacitance measurement.

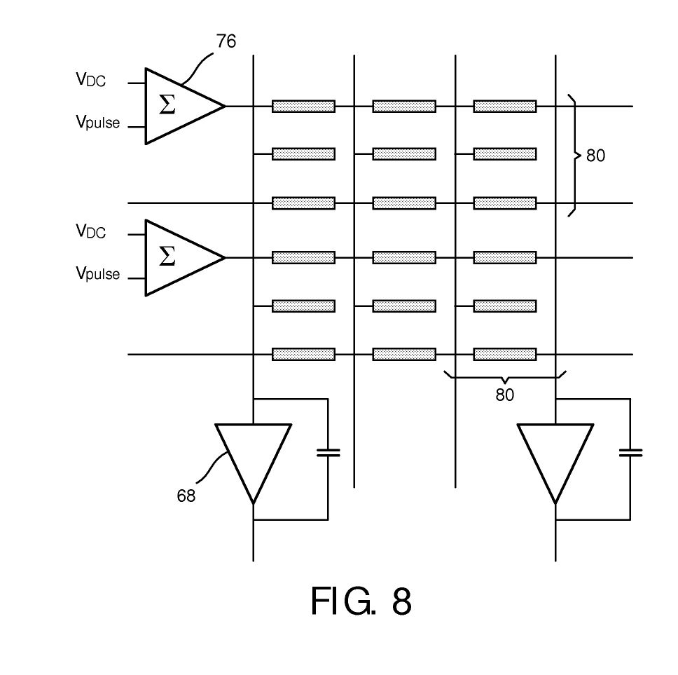

Although the driving scheme has been described for a single electrode, arrays of electrodes can also be driven in the same manner. Depending upon the electrode layout, the capacitance of the touch-sensing electrodes would be sampled for groups of one or more pixels in a matrix fashion and these capacitances measured in consecutive rows as shown in FIG. 8, or for custom electrode layouts the capacitances could be measured sequentially. When the display electrodes are arranged in a regular matrix of rows and columns, the capacitance between each row and column could be measured in consecutive rows in order to indicate the position of the touch event.

As shown in FIG. 8, pixels in the rows and columns can be arranged in groups 80.

The capacitance sensing is based on analysis using in-plane electrodes, and typically these will comprise row and column electrodes. The touch sensing does not require physical contact as it is not dependent on deformation of the cell, and it instead relies upon the change in electric field pattern in the vicinity of the display. The electric field lines are designed to fringe out towards the user for this purpose, so that a projected capacitance detection approach is used. The structure of the display can be fully rigid if desired, although flexible displays may also be implemented.

The embodiments described above are based on an in-plane display design with no ground electrode. In-plane movement of electrophoretic displays can be combined with transverse particle movement in a so called “hybrid” electrophoretic display. This type of display has in-plane electrodes (as in the examples above) but additionally makes use of a ground plane to provide a greater number of pixel display states. Thus, another aspect of the invention combines this hybrid display design with touch sensing capability, again using the same electrodes.

Hybrid electrophoretic displays are neither exclusively in- nor out-of-plane. Compared to pure in-plane and out-of-plane electrophoresis this arrangement offers a number of advantages: unlike out-of-plane electrophoresis, hybrid electrophoresis offers a transparent state. A transparent state is essential for bright, full color (because it allows stacking) and is also required for all applications involving windows or hiding and most applications involving luminaries. In addition, the hybrid approach offers built-in gray-scales. Built-in means that the gray-scales only depend on the application of a potential to the drive electrodes. There is no need for complicated driving schemes. In comparison to in-plane electrophoresis, hybrid electrophoresis offers a simpler layout, lower requirements for manufacturing/alignment, driving and potentially shorter switching times (due to the smaller distances that the particles need to move).

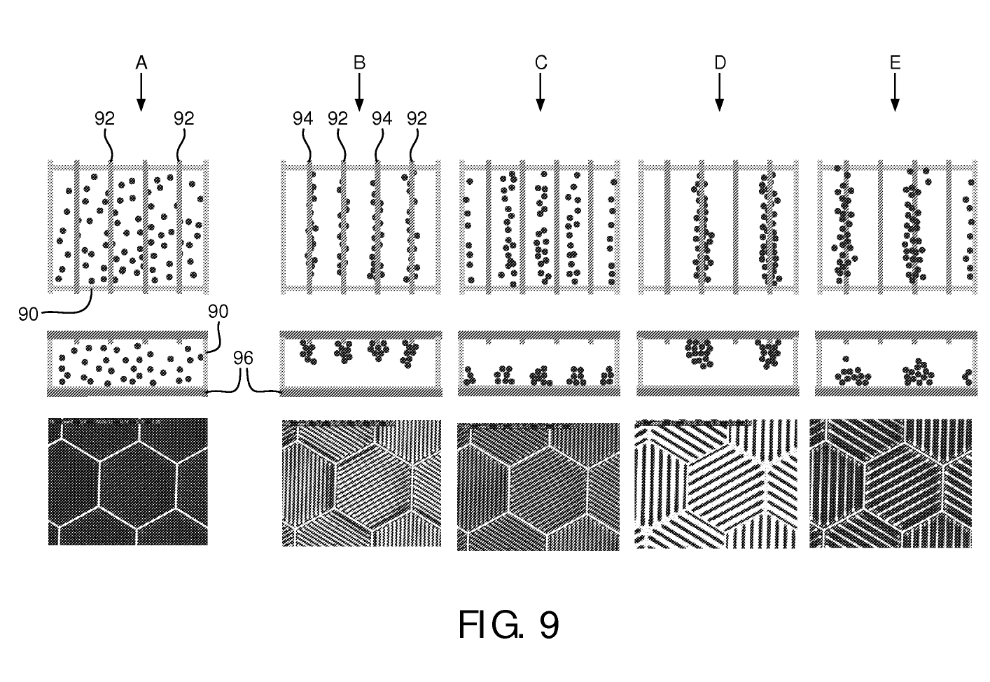

FIG. 9 is used to explain the way such a hybrid display functions. Each column of images shows a top view (the top row of images), a side view (the middle row of images) and a microscope image (the bottom row of images).

The display is divided into cells 90. In the example shown, each cell has four in-plane control electrodes, controlled with two control signals. One pair of electrodes 92 is controlled by one drive signal and the interleaved pair of electrodes 94 is controlled by another drive signal. There is also a ground electrode 96 on the opposite (vertical) side of the cell.

The cell comprises absorbing particles in a transparent medium.

In a black state (column A), the particles are uniformly distributed within the cell, and all electrodes are at ground potential.

In a first grey state (column B), the particles are all clustered at the control electrodes. All control electrodes have the same attractive potential applied, for example positive to attract negatively charged particles.

In a second grey state (column C) the particles are all clustered at the ground electrode, in lateral positions between the control electrodes. All control electrodes have the same repulsive potential applied, for example negative to repluse negatively charged particles. This is a darker state, because the particles are less tightly clustered due to the increased distance from the electrodes.

In a third grey state (column D) the particles are all clustered at one set of control electrodes. One set of control electrodes has an attractive potential applied, and the other is grounded. This is a lighter state than column B, because the particles are more tightly clustered in a smaller number of locations.

In a fourth grey state (column E) the particles are all clustered opposite one set of control electrodes. One set of control electrodes has a repulsive potential applied so that the particles collect opposite the other electrode set which is grounded. This is a darker state than column D, because the particles are less tightly clustered.

The touch sensing approach of the invention can also be applied to this type of display device. As outlined above, care needs to be taken to ensure that the ground plane does not act as a shield, and this can be achieved by re-using the common ground plane and at least two patterned electrodes (on the viewer side of the display) as part of the touch sensing circuit.

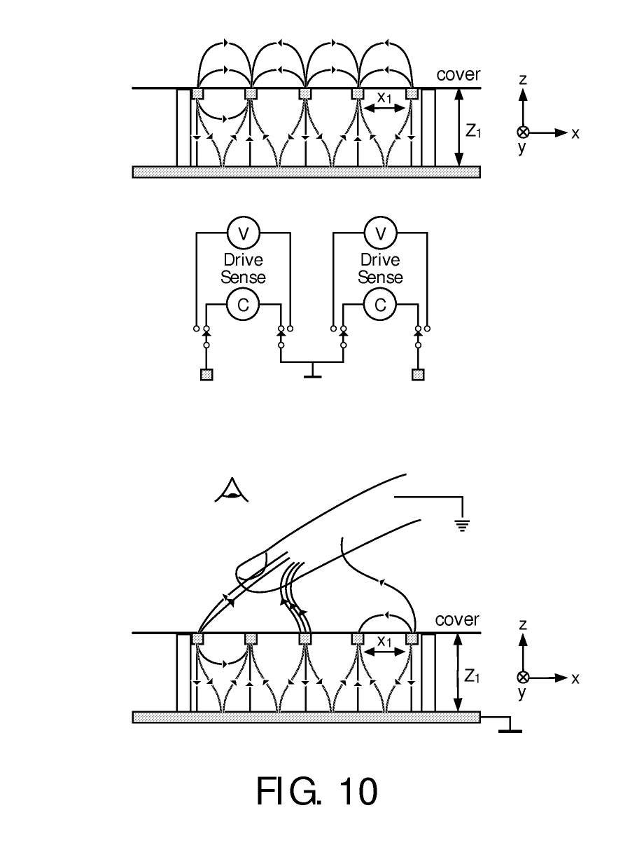

The example of FIG. 9 has two patterned electrodes on one side of a cell filled with an electrophoretic suspension and a non-patterned electrode on the other side. FIG. 10 shows two side views of the arrangement to show the electric field lines and the effect of a touch input. A basic electric circuit is also shown to outline the principle of operation of a differential capacitance touching-sensing detection circuit. Independent of the gray-scale driving level, the sensing field lines must project beyond the cover, flowing between the two patterned drive electrodes.

The two electrodes are preferably driven 90 degrees out of phase. When a finger approaches the hybrid electrophoretic skin the measured stray-capacitance (cross-talk) between the electrodes becomes affected. Detection of this change may be done by time-multiplexed sense/drive cycles as shown schematically in the circuit diagram. However, the stray capacitance can instead by sensed continuously by injection of an AC sensing component on top of the DC drive field, thereby enabling continuous touch-sensing while driving

As shown in FIG. 10, the at least two patterned electrodes are located at the near side of the viewer. They can be driven independently, and are placed opposing the common non-patterned ground.

The patterned electrodes may for example form parallel lines. Typically, the particles are negatively charged, and the non-patterned electrode is grounded, although positively charged particles can be used, and a non-zero voltage for the common electrode is also possible. Touch detection is based on detecting a change in the cross-talk capacitance between the at least two patterned drive electrodes. This cross-talk, as shown by the lower part of FIG. 10, is affected when a parasitic ground plane, represented by a finger, approaches the AC driven sense capacitors. The largest protrusion of the field lines will be obtained when the phase difference between the potential at the first and that at the second patterned electrode differs by 90 degrees. Thus by phase detection or impedance analysis, a touch-input may be detected (for example see U.S. Pat. No. 7,368,923 for differential capacitance sensing.

By using the presence of the non-patterned ground at the viewer's far side, in combination with differential capacitive sensing, a very high level of intrinsic robustness is ensured.

The reason for the improved robustness stems from the fact that the electric properties of any colloidal dispersion may be subjected to changes (unintentional and/or unpredictable), thereby substantially complicating a fast and reliable detection of a touch event. In addition, the electric properties of a colloidal dispersion may also change due to driving, temperature or aging. Since the electrophoretic dispersion comprises charged species, which are displaced under the application of an electric field, the reliable detection of a touch-input substantially depends on steady -state electric properties. Hence, in the driven state, for which the charge density is different from that in the non-driven state, drive, sample, hold and compare schemes must be used, in addition to the requirement to measure small changes in the absolute value of the sensed capacitance.

An advantage of built-in touch-sensing for hybrid electrophoresis is that it hardly puts less demands on the electric properties of the colloidal dispersion, thereby enabling improved robustness. Moreover, improved robustness is intrinsic to hybrid electrophoresis, and hybrid electrophoresis allows for the use of differential sensing techniques. The key advantage of using differential sensing techniques is that they are faster and more sensitive than conventional touch-sensing techniques. In particular, a change in the electric properties of the colloidal dispersion due to driving, aging or temperature equally affects the value of both capacitances between the patterned electrodes and the common ground. Thus, differential touch sensing techniques may be employed based on for example vector, threshold or window comparison methods, with the differential touch sensing (AC driven) being employed continuously or time-sequentially. There is also no the need for position calibration.

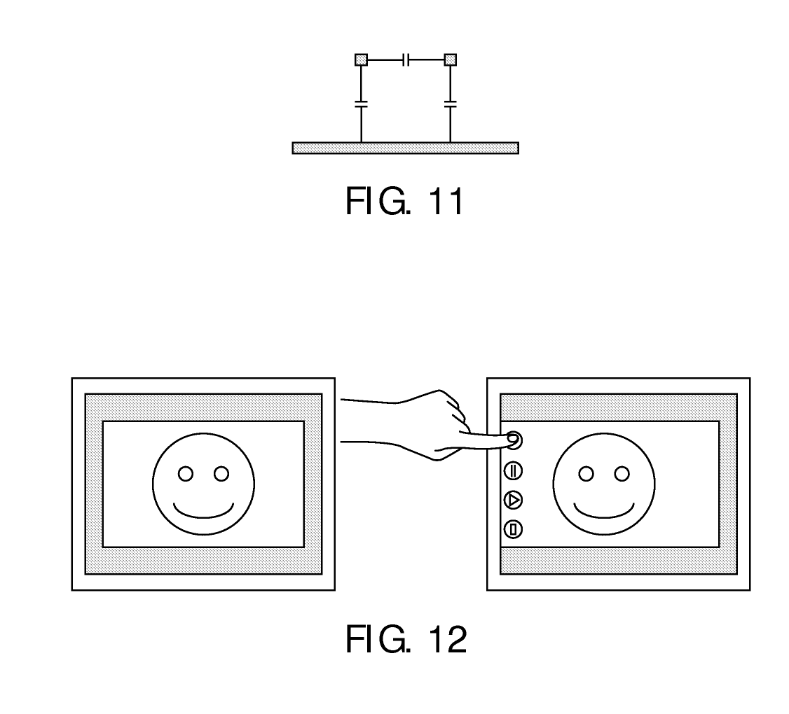

Instead of differential capacitance measurement, a so-called two port S-parameter measurement may be performed by considering the electrodes as a network of capacitors, terminated by a common ground. This is represented in FIG. 11, in which the capacitance between the electrodes is a stray capacitance. In this case, the value of the stray capacitance may be determined by injecting a first AC signal into one electrode, while sensing the returned signal at the other electrode, and next vice versa. Then the value of the cross-capacitance can be calculated. A change in the measured value, due to touching the display may then be detected.

Alternatively, a one port approach may also be used to analyse the stray capacitance, by putting the 2-port S-matrix into a linear simulator. Then, by shorting one port to ground, a 1 port circuit is realized, which can be analyzed by plotting S11 in R+jX format, where the imaginary part is the reactance (stray-capacitance C11 between the first and second patterned electrode). Also here, a change in C11 may be interpreted as a touch-input.

The addition of a further independently driven patterned electrode will double the number of grey states (plus the black level) and may be used to expand the differential capacitance sensing method. Therefore an arrangement with 3, 4, 5, . . . independently addressable electrodes will yield 9, 17, 33, . . . greyscales respectively. For differential capacitance sensing the electrodes may be bundled into two (time-shared) groups, which are than sensed by time-division multiplexing in order allow for different DC values of the drive field.

Different electrode shapes can be used. The common ground resistivity can be selected to aim for an optimized S-parameter measurement. The electrodes can have the same widths, but using different widths for the first and second electrodes is also possible. Similarly, symmetric or asymmetric spacing between the first and second patterned electrodes is possible. A frequency-sweep rather than sensing at a fixed frequency can be used.

The invention can also be applied to gas based electrophoretic systems (for example using Bridgestone Tribological charged particles) rather than a liquid filled device. In the Bridstone (Quick Response Liquid Powder) approach, two particle types having different optical appearance and of opposing signs are displaced in a gas rather than in a fluid. Hence, they can be displaced much faster. The voltages used to drive this type of device is typically much larger than those used in fluid based electrophoretic systems, and, hence the field may protrude further out of the display plane, making it easier to detect changes in capacitance.

The above embodiments describe the use of the invention in pixellated display devices in which the pixel cells are typically arranged in a regular matrix structure and driven independently. The invention can also be used to provide a means of interaction with display devices in which the pixels are electrically grouped together in a regular or irregular pattern to form one or more large-pixels which constitute a segmented display. In such segmented display devices, for example those which use the in-plane electrophoretic effect, it is again common for the sub-pixels (the smallest unit cell) to be arranged on a regular grid structure to ensure uniformity in the display's operation as well as to comply with manufacturing requirements.

However, by grouping the sub-pixels together and driving them as a large-pixel, not only is their control simplified but other applications are enabled. A typical application that uses this functionality is a so-called ‘hiding panel’ in which it is desired to expose (permit optical transmission) or conceal (block parts of the optical spectrum) an object behind the hiding panel. Such a hiding panel can for example be used to conceal or reveal parts of a logo.

Having electrically grouped the driving of the pixels together into a block of pixels, the touch sensor interactivity is no longer restricted to the resolution across each sub-pixel in the underlying regular array, but the spatial resolution of the interactivity is now determined by the electrical grouping that defines the large-pixel. As before, the same field lines from the electrodes that drive the display effect penetrate through the front of the hiding panel permitting interactivity with a user. When electrically grouped together in this way, the change in capacitance that is measured is that summed across all sub-pixels in a large pixel. As the large-pixel size increases, the percentage change in capacitance that results from the introduction of a fixed-sized grounded finger will decrease. This provides a practical limit to the size of large pixel over which detectable interactivity can be achieved.

This ‘hiding panel’ application is not a display device as such, but is an output device which has different light transmission characteristics. Thus, it can be seen that the invention is also applicable to devices which would not normally be considered as displays. However, the IPEP effect is still the same effect as in display devices.

Multiple large-pixels can be defined in the panel, for example to reveal individual sections of the same logo. It could also be used to reveal security information behind separate large-pixels on for example a credit card. In another embodiment, the display effect can also be used to reveal control buttons when a user approaches an interactive panel, causing the individual control buttons to change appearance when the user activates a particular control input.

An example is shown in FIG. 12, in which the entire bezel of a picture frame appears a uniform color in the absence of a user's finger (the left image). As the user's finger approaches any of the control inputs in a defined region of the bezel (as shown in the right image), the hiding panel reveals the control inputs. If the user holds their finger in front of a particular control input for a predetermined period, this activates the control, causing for example the picture to advance to the next one in the sequence. The activation can be identified to the user by for example flashing (rapidly hiding and then concealing) the appearance of the particular control, or by changing the intensity or color of an illumination device located behind the hiding panel. The bezels of television displays could also be operated in the same manner.

The sub-pixels do not need to be regular as in the examples above. Instead, each touch sensor activation region can be a single pixel of any desired shape.

The invention can be applied to large panels, for example the glass wall of a meeting room. This wall can be provided with a controllable touch-controlled hiding-panel function in order to control privacy. Thus, a region of the glass wall can be switched between an opaque state and a transparent state. The transparent state can still include images, for example company logos.

A hiding panel of the invention can be used to interrupt part of the optical spectrum in a projection system. Such a hiding panel can be used to provide interactivity with lighting effects by spatially modulating the temporal and spectral intensity of images that are either projected on a distant surface screen, or images that are on the surface of a luminaire. In the latter case the projection surface is also the touch-interactive surface.

The invention thus has application in all existing display and touch-sensing systems as well as to other devices, such as touch-interactive panels for consumer products, and hiding panels that cover the surface of a high resolution display such as the iPhone whilst in one state, and which reveal the active display in another state.

Larger area interactive applications are also enabled, such as large privacy screens on glass walls that benefit from seamlessly-integrated touch-input control to generate exciting visual effects.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. An output device having touch sensor input functionality, comprising:
at least first and second control electrodes (40,42) lying in a common plane over a common substrate (46) for controlling a light transmission characteristic of the device, and
a suspension of charged particles (50) in a layer overlying the common substrate (46),
wherein the device is operable in at least two modes, comprising:
a first mode in which the light transmission characteristics are altered by controlling the movement of the charged particles (50) under the influence of control signals applied to the first and second control electrodes (40,42), and
a second mode in which the first and second control electrodes (40,42) are coupled to a capacitance sensing means (56), for detecting a change in capacitance caused by the proximity of an object to be detected.

2. A device as claimed in claim 1, comprising an electrophoretic passive or active matrix display device having an array of rows and columns of display pixels disposed over the common substrate (46), wherein each pixel comprises respective first and second control electrodes and a respective suspension of charged particles.

3. A device as claimed in claim 1, wherein an insulating cover layer (16) is provided over the charged particle layer.

4. A device as claimed in claim 3, wherein in the second mode, electric field lines (48) between the first and second control electrodes extend beyond the cover layer.

5. A device as claimed in claim 1, further comprising a control circuit (54) for controlling the switching between the first and second modes in a time division multiplex manner.

6. A device as claimed in claim 5, wherein the control circuit applies DC control voltages to the control electrodes (40,42) in the first mode, and applies a pulsed sense voltage between the control electrodes in the second mode.

7. A device as claimed in claim 1, further comprising a control circuit (54) for applying control voltages to the control electrodes comprising a pulsed or AC sense voltage for the second mode with a superposed DC offset for the first mode, wherein the first and second modes are implemented at the same time.

8. A device as claimed in claim 1, wherein in the second mode the detected change in capacitance relates to the capacitance between the first and second electrodes (40,42), or the capacitance between each electrode (40,42) and a ground.

9. A device as claimed in claim 1, further comprising a ground plane spaced from the common plane of the first and second electrodes, wherein the detected change in capacitance comprises the differential capacitance of the first and second electrodes to the ground plane.

10. A method of controlling the light transmission characteristics of an output device and implementing a touch sensor function, using an output device comprising at least first and second control electrodes (40,42) lying in a common plane over a common substrate (46) for controlling a light transmission characteristic of the device and a suspension of charged particles (50) in a layer overlying the common substrate (46), comprising:
in a first mode, altering the light transmission characteristics by controlling the movement of the charged particles (50) under the influence of control signals applied to the first and second control electrodes (40,42), and
in a second mode, coupling the first and second control electrodes (40,42) to a capacitance sensing means, for detecting a change in capacitance caused by the proximity of an object to be detected.

11. A method as claimed in claim 10, wherein in the second mode, electric field lines (48) between the first and second control electrodes (40,42) are generated which extend beyond a cover layer (16) of the device.

12. A method as claimed in claim 10, comprising switching between the first and second modes in a time division multiplex manner.

13. A method as claimed in claim 12, wherein either:
DC control voltages are applied to the control electrodes in the first mode, and a pulsed or AC sense voltage is applied between the control electrodes in the second mode, or
control voltages are applied to the control electrodes comprising a pulsed or AC sense voltage for the second mode with a superposed DC offset for the first mode, wherein the first and second modes are implemented at the same time.

14. A method as claimed in claim 10, wherein the second mode the detected change in capacitance relates to the capacitance between the first and second electrodes (40,42), or the capacitance between each electrode (40,42) and a ground.

15. A method as claimed in claim 10, comprising operating an electrophoretic passive or active matrix display device having an array of rows and columns of display pixels disposed over the common substrate (46), wherein each pixel comprises respective first and second control electrodes and a respective suspension of charged particles.
